(19) United States
(12) Patent Application Publication
(10) Pub. No.: US 2013/0191081 A1
(43) Pub. Date: Jul. 25, 2013

(54) CREATING A WELL PATH

(71) Applicants: Vivek Jain, Beijing (CN); Qing Liu, Beijing (CN); Paul Thow, Spring, TX (US)

(72) Inventors: Vivek Jain, Beijing (CN); Qing Liu, Beijing (CN); Paul Thow, Spring, TX (US)

(21) Appl. No.: 13/549,752

(22) Filed: Jul. 16, 2012

Related U.S. Application Data
(60) Provisional application No. 61/507,802, filed on Jul. 14, 2011.

(51) Int. Cl. G06F 17/50

(52) U.S. Cl. CPC G06F 17/50
USPC 703/1

(57) ABSTRACT

A method or methods, and systems and computer program products for performing or executing such method(s), comprising developing a well plan based on a plurality of points in three-dimensional space, refining the well plan to remove noise, smoothing the refined well plan, adjusting resolution of the smoothed well plan, converting the resolution-adjusted well plan into a plurality geometric shapes, mapping the plurality of geometric shapes to ones of a plurality of drillable shapes via image processing and pattern recognition, and optimizing the mapped well plan by synthesizing into at least one drillable profile.

### CROSS-REFERENCE TO RELATED APPLICATIONS

This application claims the benefit of U.S. Provisional Application No. 61/507,802, entitled “Creating a Well Path,” filed Jul. 14, 2011, the entire disclosure of which is hereby incorporated herein by reference.

### BACKGROUND OF THE DISCLOSURE

A Well Plan may be composed of a set of shapes that can be drilled in the ground for many purposes, including but not limited to hydrocarbon extraction, hydrocarbon injection, steam injection, relief, geothermal, and carbon sequestration.

### BRIEF DESCRIPTION OF THE DRAWINGS

The present disclosure is best understood from the following detailed description when read with the accompanying figures.

FIG. 1 is a flow-chart diagram of at least a portion of a method according to one or more aspects of the present disclosure.

FIG. 2 is a flow-chart diagram of at least a portion of a method according to one or more aspects of the present disclosure.

FIG. 3 is a flow-chart diagram of at least a portion of a method according to one or more aspects of the present disclosure.

FIG. 4 is a flow-chart diagram of at least a portion of a method according to one or more aspects of the present disclosure.

FIG. 5 is a flow-chart diagram of at least a portion of a method according to one or more aspects of the present disclosure.

FIG. 6 is a schematic of at least a portion of apparatus according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The present disclosure introduces one or more aspects for creating a Well Plan by drawing it freehand and then converting this into a “drilling profile” representation that can be input into any software application or computer program product used for planning and/or executing a wellbore drilling operation. According to certain geometric well trajectory design methods, selection of the drilling profiles may involve a certain level (e.g., a significant level) of expertise. In graphical design, the profile chosen between digitized points might not account for a certain drilling profile (e.g., a preferred drilling profile).

The present disclosure also introduces a realistic, drillable path between digitized points in three-dimensional space automatically, semi-automatically or through manual control. Systems and/or methods according to one or more aspects of the present disclosure may use knowledge derived from the information of additional (e.g., surrounding) wells and/or one or more earth models to guide the selection of the geometric profiles on the planned well.

The present disclosure also introduces one or more aspects of deriving a “drilling profile” representation of a well plan from a series of survey stations or a set of points defining the Well Path. Such aspects may be beneficial when an actual well trajectory has been drilled and an attempt is made to derive the original Well Plan, or when the Well Plan is exported as a series of survey stations or points and subsequently imported into another system with incomplete or inadequate information.

In general, an example embodiment of the present disclosure may entail taking a series of points in three-dimensional space and offering options based on knowledge derived from other well and/or earth model data. The selected or drawn plan through these points may then be cleaned for noise, smoothed and adjusted for resolution, converted into geometric shapes, mapped to a sub-set of drillable shapes through image processing and pattern recognition, and then optimized by synthesizing into drillable profiles. These actions may be performed when designing a Well Plan in a field to connect the start point, e.g., a surface location, and the target(s) in such a way that business rules are met and business objectives are achieved.

In the context of the present disclosure, a target may be a point or a multi-dimensional body. Any reference to a target, a target point, a target body or a target object herein, including in the Figures, should be interpreted as referring to any and all of these possible types of targets. A Well Plan is a continuous path in three-dimensional space that is composed of a set of Well Plan Sections. A Well Path is a series of points in three-dimensional space that represent the trajectory of a well, and may be an actual survey or interpolated points from a Well Plan. A Basis is the geometric shape that is used to represent a continuous one-dimensional (1D) path in three-dimensional (3D) space. A Drilling Profile is a set or combination of “Bases” that is accepted in designing a well and by drilling execution applications, and that is adaptive to accommodate small modifications in smaller scale in reality, when there is a desire or need to keep the global borehole shape while making a limited number of small variations locally. A Well Plan Section is a partition of the well trajectory geometrical path, where the start point and end point are consistent with the ends of a Drilling Profile. A Well Plan is composed of a series of Well Plan Sections.

The start point of a Well Plan Section is a point in 3D space. Such start point could be the start point of a Well Plan, the end point of the preceding Well Plan Section, any other control point along a Well Plan, and/or a point in the target (e.g., where the target is an object, boundary, region, or area, not just a point). The user can design the Well Plan Section using a manual, automatic or semiautomatic method.

According to an example embodiment, the manual method entails the user using one or more user-operable electronic input devices, such as one or more of (without limitation) a mouse, a joystick, a trackball, a stylus, a touch screen and/or a gyroscope-equipped apparatus (such as an IPHONE). Using the input device(s), the user may draw a freehand curve in a 3D window or other input area or screen of the application. The user may choose to define the curve in the context of the earth model, in which case data around the curve may be displayed at various resolution (zoom) levels and adapted intelligently to aid the user in the design of the curve. The end of the freehand curve may define the end point, and this curve may then be processed into one or more Well Plan Sections according to the methods/processes described below.

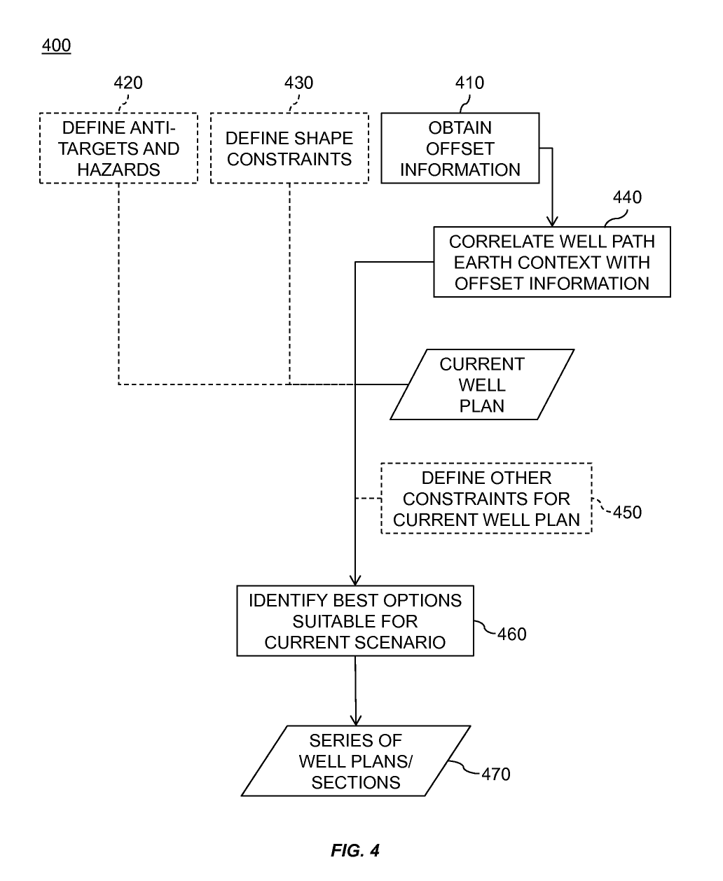

For the automatic method, once a target point is defined, the system may suggest a set of Well Path options connecting the start point and the target point, based for example on a Knowledge Application tool or process, such as that described below with respect to FIG. 4. The user can then select from the set of suggested Well Path options.

According to an example embodiment, the semiautomatic method is a combination of the above-described manual and automatic methods. There may be two semiautomatic modes from which the user can choose. The first mode may entail preselecting a shape to aid the drawing of a freehand curve in 3D space. This may, for example, provide guided drawing tools to the user to aid in defining the geometrical path to the target. The second mode may entail a combination of the freehand and automatic methods, wherein as the user draws a freehand curve, the system may compute recommended options to connect from the current point in 3D space to the target, from which the user may select in real time. The user may continue to draw freehand, in which case the suggested choices may be adjusted accordingly as the user draws, or the user may subsequently select one of the choices offered, thus defining the trajectory to the target. Additionally, while two semiautomatic methods are described above, others are also possible within the scope of the present disclosure.

In each of the above methods, the user may choose to adopt the intelligent guidance that the system computes and provides to the user in real time. Such guidance may be based on the Knowledge Application tool or process described below with respect to FIG. 4.

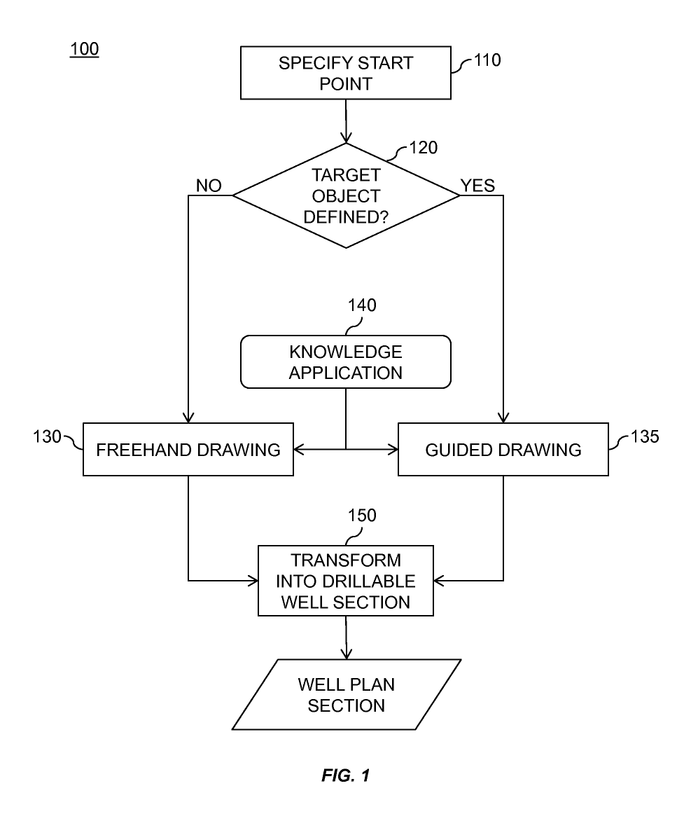

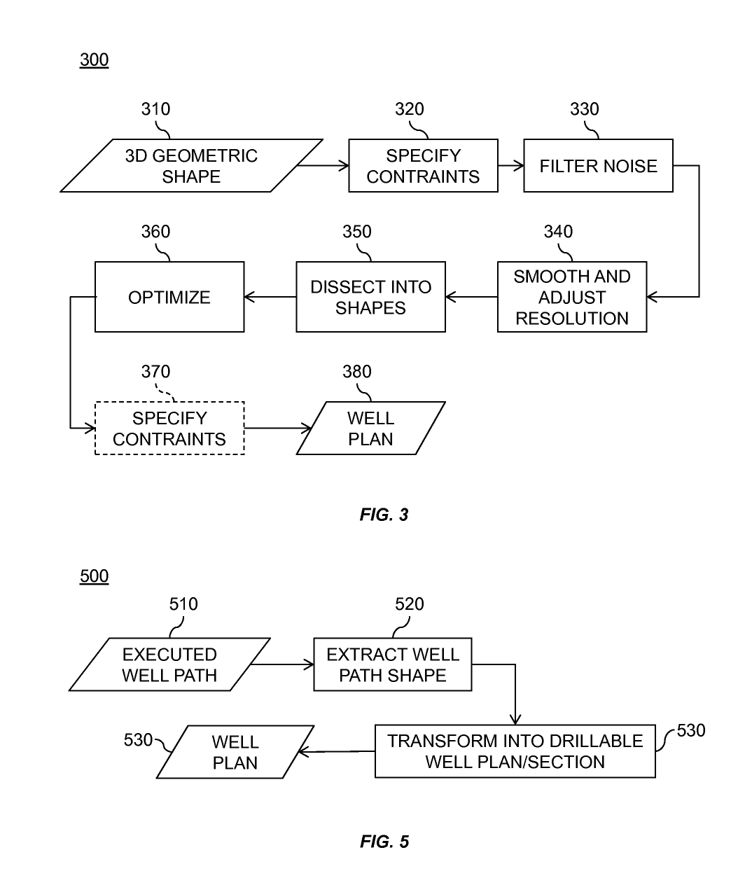

FIG. 1 is a flow-chart diagram of at least a portion of such a method 100 of creating a Well Plan Section according to one or more aspects of the present disclosure. The method 100 may include a block 110 in which the user specifies a start point to start the Well Plan Section in a Well Plan. The method 100 may also comprise the user specifying a target object. A decisional block 120 determines whether or not a target object has been specified. If no target object has been identified, the method 100 continues to block 130, during which the user sketches a 3D polyline of the Well Plan Section by freehand drawing. If decisional block 120 determines instead that a target point has been identified, the method 100 continues instead to block 135, during which the user sketches and/or selects a 3D polyline of the Well Plan Section as suggested by the above-described automatic or semiautomatic method. In either case, the Knowledge Application tool or process 140 may be executed to identify suggested potentials for the 3D polyline of the Well Plan Section. After the 3D polyline is generated by either the freehand drawing of block 130 or the guided drawing of block 135, the 3D polyline is transformed into a drillable Well Plan Section during a block 150. Such transformation may be similar to the transformation described below with respect to FIG. 3.

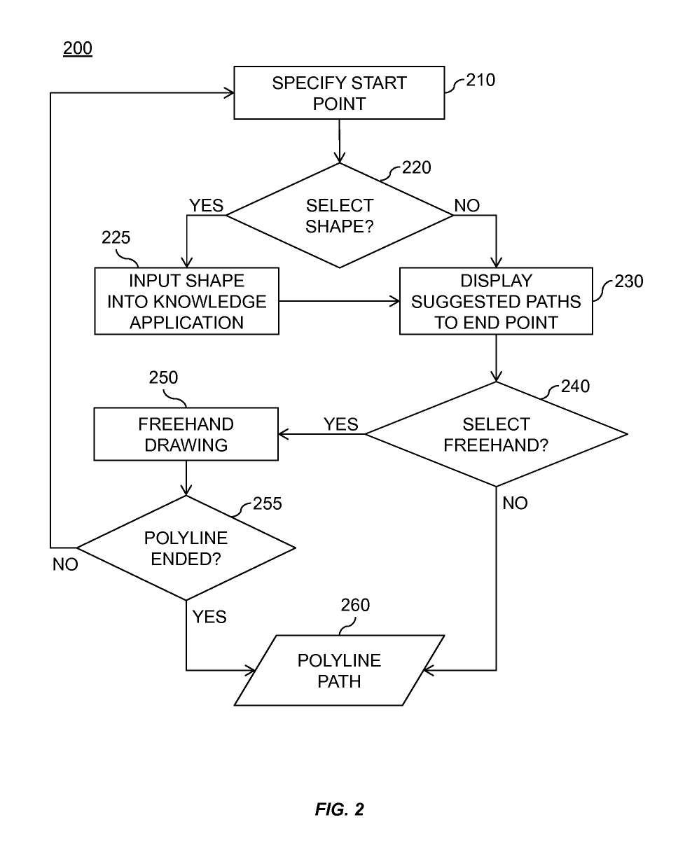

FIG. 2 is a flow-chart diagram of at least a portion of a similar method 200 of creating a Well Plan Section according to one or more aspects of the present disclosure. The method 200 shown in FIG. 2 may be used as an alternative to the method 100 shown in FIG. 1. Alternatively, aspects of each of methods 100 and 200 may be used in any combination in the creation of a Well Plan Section within the scope of the present disclosure.

The method 200 includes a block 210 in which a start point is specified by the user. The start point may be a point along the Well Plan Section or a point in 3D space. Subsequent decisional block 220 then determines whether a specific geometric shape, Basis or profile (collectively referred to as “shape” in FIG. 2 and herein) has been chosen by the user to constrain the shape of the Well Plan Section. If it is determined via block 220 that the user has specified a specific geometric shape to constrain the Well Plan Section, the method 200 proceeds to a block 225 during which the user-selected shape is input into the Knowledge Application tool or process described below with respect to FIG. 4. If it is determined via block 220 that the user has not specified a specific geometric shape to constrain the Well Plan Section, or after execution of block 225, the method 200 proceeds to block 230, during which paths to the end point suggested by the Knowledge Application tool or process are displayed to the user. Such display may comprise a set of 3D polylines displayed in a 1D, 2D or 3D display area or screen of the system.

The user is then given the option to either select freehand drawing of the Well Plan Section or to select one of the paths suggested by the Knowledge Application tool or process. A decisional block 240 determines which of these options is selected by the user. If it is determined via the decisional block 240 that the user has selected one of the suggested paths for the Well Plan Section, then the method 200 results in the selected polyline, indicated as data 260 in FIG. 2. If, instead, it is determined via the decisional block 240 that the user has elected to freehand draw the Well Plan Section, the method 200 continues to block 250 during which the user executes the freehand drawing. Thereafter, a decisional block 255 determines whether the user's freehand drawing represents the end of the polyline of the Well Plan Section. If it is determined via block 255 that the end of the polyline has not yet been reached by the user's freehand drawing, then the method 200 iterates by returning to block 210, using the endpoint of user's freehand drawing as the new start point for the subsequent iteration. However, if it is determined via block 255 that the end of the polyline has been reached by the user's freehand drawing, then the method 200 results in the completed polyline, indicated as data 260 in FIG. 2. The data 260, comprising a polyline extending the length of the desired Well Plan Section, may thereafter be forwarded for additional processing.

After one or more Well Plan Sections have been generated via method 100 of FIG. 1 or method 200 of FIG. 2, or via one or more aspects of one or both such methods, the Well Plan Section(s) may be transformed into a drillable Well Plan through a series of shape and image processing, pattern recognition and optimization processing. FIG. 3 is a flow-chart diagram of at least a portion of a method 300 of such transformation according to aspects of the present disclosure.

The method 300 utilizes data 310 which comprises a 3D geometric shape of one or more Well Plan Sections. The one or more Well Plan Sections may be, or comprise, one or more polyline curves generated by, for example, aspects of the method 100 shown in FIG. 1 and/or aspects of the method 200 shown in FIG. 2.

During block 320, the user may specify various constraints. Examples of such constraints may include indicating certain parts of the 3D curve from data 310, or certain points along such 3D curve, that should be fixed and/or be treated differently in subsequent blocks, or specifying envelope parameter(s) within which some or all parts of the Well Plan should be maintained.

A noise filter operation in subsequent block 330 at least reduces (e.g., eliminates) noise (e.g., spikes) contained in the 3D curve of data 310, although within the constraints of block 320. Such filtering may utilize any one or more conventional or future-developed processing methods. Examples within the scope of the present disclosure may include utilizing adaptive, linear and/or non-linear filters to at least reduce (e.g., eliminate), for example, jitter caused during any graphical drawing and/or capturing processes, and any noise present in the input data. However, these are examples, and are not considered to limit the scope of the present disclosure.

During subsequent block 340, the noise-filtered curve is then smoothed, and the resolution is adjusted as desired for input into the next blocks of shape and image processing and pattern recognition. Such smoothing and resolution adjustment is performed within the constraints of block 320. Moreover, such smoothing and resolution adjustment may utilize any number of conventional or future-developed processing methods. Examples of smoothing operations within the scope of the present disclosure may include moving average, interpolating, and/or moving spline, to remove discontinuities, smooth the joins between the geometric shapes, and/or smooth the data inside each geometric shape. However, these are examples, and are not considered to limit the scope of the present disclosure. Examples of resolution-adjusting operations within the scope of the present disclosure may include data scaling, coding, and/or collating to reduce the size of data and form an input for classification into Basis in the next block. Smoothing and/or interpolation may aid in deriving discrete profiles from the underlying continuous geometric shape. However, these are examples, and are not considered to limit the scope of the present disclosure.

In a subsequent block 350, the smoothed/resolution-adjusted curve is dissected into a set of unique geometrical shapes. As with earlier blocks, such dissection is performed within the constraints of block 320. The dissection may utilize any one or more conventional or future-developed processing methods. Examples within the scope of the present disclosure may include analyzing the data for shape change, and identifying and marking undulation, inflection and change points. However, these examples are provided as just that, and are not considered to limit the scope of the present disclosure.

In a subsequent optimization block 360, pattern recognition is performed to match the geometrical shapes resulting from the dissection of block 350 against a set of drillable shapes and profiles, which are then synthesized into drillable shapes and combined into a drillable profile (i.e., a Drilling Profile). Optimization block 360 is performed within the constraints of block 320. Such pattern recognition may utilize any number of conventional or future-developed processing methods. Examples of pattern recognition operations within the scope of the present disclosure may include extracting certain pattern parameters (e.g., angles and/or curvatures) from the dissected shapes and matching them against Basis pattern parameters to classify the shapes into Basis. However, these are examples, and are not considered to limit the scope of the present disclosure. The above-described matching of the recognized patterns to drillable shapes and/or profiles may also utilize any number of conventional or future-developed processing methods. Examples of such matching within the scope of the present disclosure may include look-up matches, parameter and/or pattern matches. However, these are examples, and are not considered to limit the scope of the present disclosure. The above-described synthesizing may also utilize any number of conventional or future-developed processing methods. Examples of such synthesizing within the scope of the present disclosure may include look-ups and combinatorial syntheses, such as to analyze and combine the set of Bases into Profiles. However, these are examples, and are not considered to limit the scope of the present disclosure.

Once the Drilling Profile has been generated by block 360, edit control points may defined in optional block 370, such as to enable the user to edit part or all of the Well Plan Sections. For example, multiple edit modes and controls may be provided to the user to edit the size and shape of the Well Plan Sections and/or the entire Well Plan. Users may also have the flexibility to convert the edit points into Well Plan Section control points, or to split or merge Well Plan Sections into different Drilling Profiles. Block 370, and/or other blocks of the method 300, may also include a manual or automatic quality check for correctness against quality and business objectives, perhaps with real time interactive feedback to the user. Once executed, the method 300 results in a Well Plan, as indicated by reference numeral 380 in FIG. 3.

As described above, various methods and processes within the scope of the present disclosure may utilize a Knowledge Application tool or process. The Knowledge Application tool or process may incorporate knowledge from any available sources of information into the creation of a Well Plan or Well Plan Section. Such information may be a combination of data coming from one or more of anti-targets, hazards, sweet spots and offset information which may be provided from various sources and/or defined or selected by the user.

Anti-targets, also referred to interchangeably herein as avoidance objects, are the objects that a particular Well Plan must or should avoid. An anti-target may include any point or object in multi-dimensional space with a defined shape, size and/or location, and possibly including positional uncertainty. Sources of anti-targets may be manual, semiautomatic or automatic. Manual anti-targets are user-specified objects and/or scenarios to be avoided. Automatic anti-targets are generated automatically by a system based on rules defined in the system based on business and/or quality objectives. Semiautomatic anti-targets are optional objects or scenarios that are automatically computed by the system and subsequently selected by the user as being applicable to the current well plan scenario. Hazards are areas which may pose some risks or challenges in the drilling process. These may be avoidable or unavoidable.

Sweet spots are areas within which the user wants to maximize the well path. Sweet spots may be defined and/or selected via a combination of rules defined by business objectives and/or processes. Sweet spots may additionally or alternatively be defined via automatic computation achieved through coupling with an appropriate simulator. Sweet spots may additionally or alternatively be user-defined and/or selected either graphically or through other user interface mechanisms.

Offset information is the information extracted from other scenarios that pertain to the current scenario. Such information may include other Well Plans and well paths, earth models and their context, risks and events encountered during other well drilling scenarios, formation properties, earth model properties, and/or structural details, among other information also within the scope of the present disclosure.

In general, a Knowledge Application tool or process may involve providing any or all of this information as input into an engine, along with the current well plan and any user-defined constraints for the current well plan. Based thereon, the Knowledge Application tool or process outputs a set of Well Plans and/or Well Plan Sections that match against business objectives, along with information regarding the characteristics of each such Well Plan and/or Well Plan Sections. The Knowledge Application tool or process may use any or all the information available to it, and may further employ simulators (possibly including, but not limited to, geometrical, mechanical, hydraulic and fluid computation engines) to determine the optimal set.

FIG. 4 is a flow-chart diagram of at least a portion of a method 400 by which the Knowledge Application tool or process may operate. Block 410 of the method may entail fetching, receiving or otherwise obtaining offset information pertinent to the current Well Plan. Such offset information may include information regarding planned wells and risks identified, drilled wells and events, one or more trajectories, survey programs and tools, positional uncertainties, one or more bottom-hole assembly (BHA) used in the current and/or past drilling operations, one or more well casings, one or more well completions, and/or mud and/or log properties. However, these are examples, and are not considered to limit the scope of the present disclosure.

The method 400 may also include an optional block 420 during which anti-targets and/or hazards are defined and/or selected, whether via the above-described manual, semiautomatic or automatic manner. For example, block 420 may include specifying rules based on the quality objectives, business objectives and/or business policies to compute the avoidance objects. Examples of quality objectives which may be utilized in determining anti-targets and/or hazards may include objectives with respect to drilling difficulty, pressure window, shallow water, object type-based entry and exit criteria, and/or event based classifications, although others are also within the scope of the present disclosure. Examples of business objectives which may be utilized in determining anti-targets and/or hazards may include one or more rates of penetration and/or other aspects of drilling performance, although others are also within the scope of the present disclosure. Examples of business policies which may be utilized in determining anti-targets and/or hazards may include policies on lease lines, although others are also within the scope of the present disclosure. Additionally, or alternatively, block 420 may include manual or geometrically guided identification or specification of any object or area to be avoided by the Well Plan.

The method 400 may also include an optional block 430 during which shape constraints may be defined and/or selected. This block 430 may entail specifying rules and/or other constraints based on quality objectives, business objectives and/or business policies to maximize the Well Plan within. These objectives and policies may be substantially similar to those described above with respect to block 420, although the objectives/policies utilized in a specific operation of block 420 may be different than the objectives/policies utilized in the corresponding operation of block 430. The definition of shape constraints occurring during block 430 may also or alternatively include manual or geometrically guided identification or specification of such constraint objects or areas.

The offset information obtained in block 410 may be subsequently utilized in block 440, during which the engine correlates the offset information with the earth context of the current Well Plan in design, as well as the current subsurface properties and the earth model. Block 440 also includes extracting, from any or all of the information available, information that is applicable to the current Well Plan design scenario.

The method 400 may also include an optional block 450 during which constraints other than shape constraints (as these are defined in optional block 430) may be defined and/or selected. This block 450 may entail specifying rules and/or other constraints based on quality objectives, business objectives and/or business policies to maximize the Well Plan within. Examples of these objectives and policies may be similar to those described above with respect to blocks 420 and/or 430, although the objectives/policies utilized in a specific operation of block 420 and/or 430 may be different than the objectives/policies utilized in the corresponding operation of block 450. The definition of non-shape constraints occurring during block 450 may also, or alternatively, include manual or geometrically guided identification or specification of such constraints.

The results of block 440, as well as the current Well Plan and any results from optional blocks 420, 430 and 460, are then utilized during block 460 to identify recommended options suitable for the current scenario. For example, block 460 may entail considering any or all of this information from various sources to compute a set of Well Plans and/or Well Plan Sections that best match against the business objectives. The output of block 460, for example the computed set of Well Plans and/or Well Plan Sections, is indicated in FIG. 4 as data 470.

Aspects of one or more of the above-described methods may be utilized in deriving a Drilling Profile representation of a Well Plan from a series of survey stations and/or a set of points defining the Well Path. This may also be utilized when an actual well trajectory has been drilled and an attempt is made to derive the original Well Plan, or when the Well Plan is exported as a series of survey stations and/or points and subsequently imported into another system with incomplete or inadequate information. Thus, aspects of the present disclosure may be utilized and/or adapted for such an inversion process—that is, creating a Well Plan from a Well Path. One such method 500 is shown in FIG. 5 and described below.

In a block 510, the Well Path shape is extracted from the Well Path 510 during block 520. In subsequent block 530, this 3D shape is then utilized as input for transformation into a drillable Well Plan or Well Plan Section. For example, such transformation may include one or more aspects of the method 100 shown in FIG. 1, the method 200 shown in FIG. 2, the method 300 shown in FIG. 3 and/or the method 400 shown in FIG. 4. The output of this process is a Well Plan, as indicated by reference numeral 540 in FIG. 5.

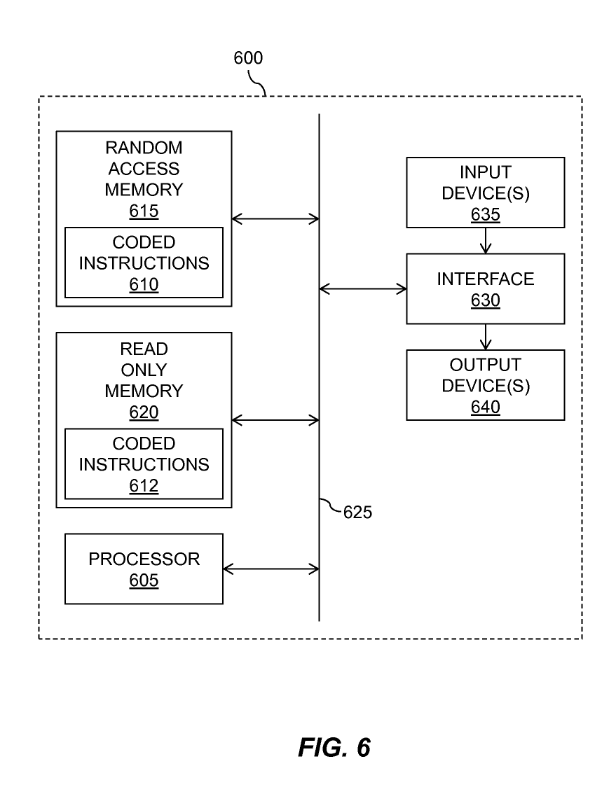

FIGS. 1-5 illustrate examples that may be carried out to implement any or all of the example methods/processes described herein, and each may be embodied within an actual or virtual “module” of a software application or computer program product. Moreover, the example methods/processes of FIGS. 1-5 may be carried out by one or more processors, one or more controllers and/or any other suitable processing device(s). For example, the methods/processes of one or more of FIGS. 1-5 may be embodied in coded instructions stored on a tangible medium, such as a flash memory, a read-only memory (ROM) and/or random-access memory (RAM) associated with one or more processors (e.g., the example processor 605 discussed below in connection with FIG. 6), among other options within the scope of the present disclosure. Alternatively, some or all of the example methods/processes of FIGS. 1-5 may be implemented using any combination(s) of circuit(s), ASIC(s), PLD(s), FPLD(s), discrete logic, hardware, firmware, etc., among other options within the scope of the present disclosure. Additionally, some or all of the example methods/processes of FIGS. 1-5 may be implemented manually or as any combination of any of the foregoing techniques, for example, any combination of firmware, software, discrete logic and/or hardware, among other options within the scope of the present disclosure. Further, although the example operations of FIGS. 1-5 are described with reference to the flow-chart diagrams of FIGS. 1-5, many other methods/processes of implementing the operations of FIGS. 1-5 may be employed. For example, the order of execution of the blocks may be changed, and/or one or more of the blocks described may be changed, eliminated, sub-divided or combined. Additionally, any or all of the example methods/processes of FIGS. 1-5 may be carried out sequentially and/or carried out in parallel by, for example, separate processing threads, processors, devices, discrete logic, circuits, etc., among other options within the scope of the present disclosure.

FIG. 6 is a schematic illustration of an example processor platform 600 that may be used and/or programmed to carry out the example methods/processes of one or more of FIGS. 1-5, such as to implement any or all of the example methods and apparatus described herein. For example, the processor platform 600 can be implemented by one or more general purpose processors, processor cores, microcontrollers, etc.

The processor platform 600 of the example of FIG. 6 includes at least one general purpose programmable processor 605. The processor 605 may execute coded instructions 610 and/or 612 present in main memory of the processor 605 (e.g., within a RAM 615 and/or a ROM 620). The processor 605 may be any type of processing unit, such as a processor core, a processor and/or a microcontroller. The processor 605 may execute, among other things, the example processes of one or more of FIGS. 1-5 to implement the example methods and apparatus described herein.

The processor 605 may be in communication with main memory, which may include ROM 620 and/or RAM 615, via a bus 625. The RAM 615 may be implemented by dynamic random-access memory (DRAM), synchronous dynamic random-access memory (SDRAM), and/or any other type of RAM device, and ROM 620 may be implemented by flash memory and/or any other desired type of memory device. Access to the RAM 615 and the ROM 620 may be controlled by a memory controller (not shown).

The processor platform 600 also includes an interface 630. The interface 630 may be implemented by any type of interface standard, such as an external memory interface, serial port, general purpose input/output, etc. One or more input devices 635 and one or more output devices 640 are connected to the interface circuit 630, and may include one or more of a mouse, a joystick, a trackball, a stylus, a touch screen, a gyroscope-equipped apparatus and an active or passive display.

In view of the above and the Figures, one or ordinary skill in the art should readily recognize that the present disclosure introduces a method comprising: developing a well plan based on a plurality of points in three-dimensional space; refining the well plan to remove noise; smoothing the refined well plan; adjusting resolution of the smoothed well plan; converting the resolution-adjusted well plan into a plurality geometric shapes; mapping the plurality of geometric shapes to ones of a plurality of drillable shapes via image processing and pattern recognition; and optimizing the mapped well plan by synthesizing into at least one drillable profile. Developing the well plan based on the plurality of points may comprise designing the well plan using a user-operable electronic input device. The plurality of points in three-dimensional space might not comprise a target point for the well plan. The user-operable electronic input device may be selected from the group consisting of: a mouse; a joystick; a trackball; a stylus; a touch screen. The user-operable electronic input device may additionally or alternatively comprise a gyroscope-equipped apparatus. Developing the well plan based on the plurality of points may comprise selecting one of a plurality of predefined shapes as a template, and then using the template to design the well plan using the user-operable electronic input device.

Developing the well plan based on the plurality of points may comprise selecting from a plurality of well path options that are automatically suggested by a knowledge application tool based on the plurality of points in three-dimensional space. The plurality of points in three-dimensional space may comprise a target object for the well plan, wherein the target object may be selected from the group consisting of: a three-dimensional body; and a point. The knowledge application tool may suggest the plurality of well path options based on avoiding anti-targets and/or hazards. The anti-targets and/or hazards may be user-defined objects and/or scenarios to be bypassed by the well plan. The anti-targets and/or hazards may be automatically-defined objects and/or scenarios to be bypassed by the well plan based on business and/or quality objectives. The anti-targets and/or hazards may be user-selected from a plurality of automatically-defined objects and/or scenarios to be bypassed by the well plan based on business and/or quality objectives and/or policies. The knowledge application tool may suggest the plurality of well path options based on at least one sweet spot that optimizes achieving business objectives specified for the well path. The at least one sweet spot may be defined based on one or more of: one or more rules defined by business objectives and/or processes; automatic computation by an associated simulator; and one or more user-defined restrictions. The one or more user-defined restrictions may include one or more user-selected sweet spots.

The knowledge application tool may suggest the plurality of well path options based on offset information extracted from related scenarios. The offset information may be defined based on one or more of: one or more related well plans; one or more related well paths; one or more earth models; one or more earth model properties; one or more risks encountered during other previous drilling scenarios; one or more events encountered during other previous drilling scenarios; one or more formation properties; one or more structural details; one or more related well logs and/or properties; and one or more related well drilling and/or completion details.

Designing the well plan using the user-operable electronic input device may continuously trigger automatic computation of a plurality of suggested well path options for at least a portion of a remaining trajectory of the well plan. Designing the well plan may thus include selecting one of the plurality of suggested well path options.

The method may further comprise defining in the optimized well plan a plurality of edit control points collectively defining a plurality of well sections. Such method may further comprise converting the plurality of edit control points into a corresponding plurality of well section control points, each defining a corresponding one of a plurality of well sections each extending between ones of the plurality of edit control points along the associated portion of the optimized well plan. Such method may further comprise exporting one or more of the plurality of well sections for use in an additional well plan and business objective optimization simulations and solutions via feedback into a knowledge application tool.

The present disclosure also introduces a system comprising: means for developing a well plan based on a plurality of points in three-dimensional space; means for refining the well plan to remove noise; means for smoothing the refined well plan; means for adjusting resolution of the smoothed well plan; means for converting the resolution-adjusted well plan into a plurality geometric shapes; means for mapping the plurality of geometric shapes to ones of a plurality of drillable shapes via image processing and pattern recognition; and means for optimizing the mapped well plan by synthesizing into at least one drillable profile. One or more aspects of such system may be substantially similar or identical to those described above.

The present disclosure also introduces a computer program product comprising: a tangible medium having recorded thereon instructions for: developing a well plan based on a plurality of points in three-dimensional space; means for refining the well plan to remove noise; means for smoothing the refined well plan; means for adjusting resolution of the smoothed well plan; means for converting the resolution-adjusted well plan into a plurality geometric shapes; means for mapping the plurality of geometric shapes to ones of a plurality of drillable shapes via image processing and pattern recognition; and means for optimizing the mapped well plan by synthesizing into at least one drillable profile. One or more aspects of such computer program product may be substantially similar or identical to those described above.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the scope of the present disclosure, and that they may make various changes, substitutions and alterations herein without departing from the scope of the present disclosure.

The Abstract at the end of this disclosure is provided to comply with 37 C.F.R. §1.72(b) to allow the reader to quickly ascertain the nature of the technical disclosure. It is submitted with the understanding that it will not be used to interpret or limit the scope or meaning of the claims.

What is claimed is:

1. A method, comprising:
developing a well plan based on a plurality of points in three-dimensional space;
refining the well plan to remove noise;
smoothing the refined well plan;
adjusting resolution of the smoothed well plan;
converting the resolution-adjusted well plan into a plurality of geometric shapes;
mapping the plurality of geometric shapes to ones of a plurality of drillable shapes via image processing and pattern recognition; and
optimizing the mapped well plan by synthesizing into at least one drillable profile.

2. The method of claim 1 wherein the plurality of points in three-dimensional space does not comprise a target point for the well plan.

3. The method of claim 1 wherein developing the well plan based on the plurality of points comprises designing the well plan using a user-operable electronic input device.

4. The method of claim 3 wherein designing the well plan using the user-operable electronic input device continuously triggers automatic computation of a plurality of suggested well path options for at least a portion of a remaining trajectory of the well plan, and wherein designing the well plan includes selecting one of the plurality of suggested well path options.

5. The method of claim 3 wherein the user-operable electronic input device is selected from the group consisting of: a mouse; a joystick; a trackball; a stylus; and a touch screen.

6. The method of claim 3 wherein the user-operable electronic input device comprises a gyroscope-equipped apparatus.

7. The method of claim 1 wherein developing the well plan based on the plurality of points comprises selecting one of a plurality of predefined shapes as a template, and then using the template to design the well plan using the user-operable electronic input device.

8. The method of claim 1 wherein developing the well plan based on the plurality of points comprises selecting from a plurality of well path options that are automatically suggested by a knowledge application tool based on the plurality of points in three-dimensional space.

9. The method of claim 8 wherein the plurality of points in three-dimensional space comprises a target object for the well plan, wherein the target object is selected from the group consisting of:
a three-dimensional body; and
a point.

10. The method of claim 8 wherein the knowledge application tool suggests the plurality of well path options based on avoiding anti-targets.

11. The method of claim 10 wherein the anti-targets are user-defined objects and/or scenarios to be bypassed by the well plan.

12. The method of claim 10 wherein the anti-targets are automatically-defined objects and/or scenarios to be bypassed by the well plan based on business and/or quality objectives.

13. The method of claim 10 wherein the anti-targets are user-selected from a plurality of automatically-defined objects and/or scenarios to be bypassed by the well plan based on business and/or quality objectives and/or policies.

14. The method of claim 8 wherein the knowledge application tool suggests the plurality of well path options based on at least one sweet spot that increases a likelihood of achieving business objectives specified for the well path.

15. The method of claim 14 wherein the at least one sweet spot is defined based on one or more of:
one or more rules defined by business objectives and/or processes;
automatic computation by an associated simulator; and
one or more user-defined restrictions.

16. The method of claim 15 wherein the one or more user-defined restrictions includes one or more user-selected sweet spots.

17. The method of claim 8 wherein the knowledge application tool suggests the plurality of well path options based on offset information extracted from related scenarios.

18. The method of claim 17 wherein the offset information is defined based on one or more of:
one or more related well plans;
one or more related well paths;
one or more earth models;
one or more earth model properties;
one or more risks encountered during other previous drilling scenarios;
one or more events encountered during other previous drilling scenarios;
one or more formation properties;
one or more structural details;
one or more related well logs and/or properties; and
one or more related well drilling and/or completion details.

19. The method of claim 1 further comprising:
defining in the optimized well plan a plurality of edit control points collectively defining a plurality of well sections; and
converting the plurality of edit control points into a corresponding plurality of well section control points each defining a corresponding one of a plurality of well sections each extending between ones of the plurality of edit control points along the associated portion of the optimized well plan.

20. The method of claim 19 further comprising exporting one or more of the plurality of well sections for use in an additional well plan and business objective optimization simulations and solutions via feedback into a knowledge application tool.
